(19) United States
(12) Patent Application Publication
(10) Pub. No.: US 2008/0177606 A1
(43) Pub. Date: Jul. 24, 2008

(54) METHOD AND SYSTEM FOR ALLOCATING CALLS TO CALL CENTER VENDORS

(75) Inventors: Ching-Hua Chen-Ritzo, Mahopac, NY (US); Daniel Connors, Pleasant Valley, NY (US); Laura Wynter, Chappaqua, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/624,316

(22) Filed: Jan. 18, 2007

(51) Int. Cl. G06F 17/30; G06Q 30/00

(52) U.S. Cl. 705/8; 705/30

(57) ABSTRACT

A system (and method) for allocating a contact to a vendor includes determining a real-time allocation of contact based upon one of a client-to-service provider payment structure, a service provider-to-vendor payment structure, and a real-time client contact handling demand.

### BACKGROUND OF THE INVENTION

1. Field of the Invention

The present invention generally relates to a method and system for allocating calls to call center or contract center vendors. In particular, the present invention relates to a method and system for allocating calls to call center or contact center vendors based upon contract terms to improve profitability.

2. Description of the Related Art

FIG. 1 illustrates a contact center environment 100. The environment 100 includes a client 102 that has a need for handling contacts, such as telephone calls. A client 102 may engage a service provider 104 and negotiate a contract with the service provider 104 to arrange to handle contacts for the client 102. In turn, the service provider 104 may outsource the handling of the contacts to one or a plurality of vendors 106. The service provider 104 may enter into a contract with the vendor to handle contacts on behalf of the service provider 104 for the client 102. Each vendor 106 may include one or more call centers 108 that actually handle the contacts.

Conventional methods and tools for performing call routing and agent scheduling in contact centers are focused on many incremental improvements and cost-reducing technologies. Some conventional systems and methods rely upon selecting the agent that has been available and waiting to handle a call for the longest time. Other conventional systems rely upon skill-based routing to send calls to agents who have been performing well in recent history. Since time spent on a call with a human agent is more costly than time spent on Interactive Voice Response (IVR) systems, some conventional systems rely upon speech recognition and other technologies to increase usage of IVR systems. Yet other conventional systems focus on providing tighter coupling between call routing and workforce management. However, these improvements may or may not impact the profit of the client, contact center vendor, or multi-vendor contact center management firm (service provider).

The reason for the discrepancy is that revenue and cost for the client or service provider generally do not increase consistently with improved performance. Even when there are bonuses for good performance and penalties for poor performance, it is still generally not the case that performance increases across the board will lead to higher revenue. The reasons for this are multiple but there are three main reasons. One is that many anomalies exist in contract terms and conditions that determine the revenue for the client and/or service provider. Another is that financial penalties and bonuses are usually defined in terms of service quality or other performance thresholds, in that above or below a given threshold, then penalty/bonus does or does not apply. The third reason is that price structures within contact center management outsourcing contracts are often complex, and cost reduction may be possible by routing to some agents or vendors as opposed to others. These three reasons imply that the contract terms and conditions should be leveraged in routing and scheduling of contacts in order to maximize profit. The billing period must often be included as well, since many thresholds are reset for each billing period.

For example, while a conventional method for call allocation may focus upon improving performance, it is often the case that, beyond a threshold, performance improvements yield no financial benefit at all. Indeed, the call allocation of these conventional systems may cost money, especially if cheaper sites are available.

As another example, penalties may be incurred if some threshold is not met. If the current state of the system and the projected situation through the rest of the billing period suggests that the penalty will be paid, regardless of further improvements in service performance, then from that point on, it may be advantageous to focus on cost reduction rather than service performance. If, on the other hand, the current state and projections suggest that the penalty can be avoided, then increasing cost to reduce the chance of paying a large penalty may result in improved net profit. These relations are typically quite complex and can be addressed through the use of the techniques provided in this invention.

One conventional system provides a skill-based scheduling apparatus in a call center for controlling queues that uses a search engine to generate plural potential schedules for immediate and deferred queues. A user selects between the potential schedules.

Another conventional system provides an interaction request routing system for a wireless communication network that selects between human agents and/or automated systems to a process interaction request by matching the skill of the agents or automated system with skill that is required by the request.

Yet another conventional contact (call) center allocation technique matches the best available contact center agent with contacts requiring particular services. As contacts arrive, the skills that are required for each service or contact are correlated with the skills that are possessed by agents, and the best available agent is assigned to process the contact.

Another conventional method integrates call routing and workforce management functions in contact centers, thereby enabling them to work together without opposing the influence of one against that of the other. However, routing actions invalidate the core assumptions of the workforce management forecasting engine, and in fact, the problem invariably gets worse as more sophisticated (i.e., more useful) routing strategies are deployed. Existing workforce management systems were designed with basic automatic call distribution queuing in mind and do not work well with modern routing engines.

Yet another conventional method bills customers for services that are associated with routing communications from a contact center. This method charges the customer on a per-agent basis. At the end of a billing cycle, a data collection/billing unit determines the number of agents that received at least a predetermined number of communications from the contact center or the number of agents that logged into the contact center. The customer is then charged a fixed amount for each of these agents.

Another conventional method shifts agents to other activities so as to try to maintain a performance parameter in a given range.

All of the conventional methods and systems ignore the complex terms of the contracts between the parties. However, it is precisely those terms, such as, for example, the price and penalty structures, which must be taken into account for the operation to be profitable. These conventional methods and systems ignore how profit is achieved.

### SUMMARY OF THE INVENTION

In view of the foregoing and other exemplary problems, drawbacks, and disadvantages of the conventional methods and structures, an exemplary feature of the present invention is to provide a method and structure in which calls are allocated among vendors in a manner which improves profitability.

In a first exemplary aspect of the present invention, a method for allocating contacts to a vendor includes determining a real-time allocation of contact based upon any of a client-to-service provider payment structure, a service provider-to-vendor payment structure, and a real-time client contact handling demand.

In a second exemplary aspect of the present invention, a system for allocating contacts to a vendor includes a contact allocation determiner that determines a real-time allocation of contacts to the vendor based upon any of a client-to-service provider payment structure, a service provider to vendor payment structure, and a current client contact handling demand.

In a third exemplary aspect of the present invention, a system for allocating contacts to a vendor includes means for determining a real-time allocation of contacts to the vendor based upon any of a client-to-service provider payment structure, a service provider-to-vendor payment structure, and a real-time client contact handling demand.

As explained above, conventional methods and systems are limited to availability-only, or availability and skill-based routing of calls. No conventional method or system exists in which contract terms are modeled to enable real-time profit-maximizing routing and/or scheduling of calls and agents.

An exemplary embodiment of the present invention accounts for complex vendor cost structures in which it is often desirable to provide a certain quantity of calls to minimize the cost to the client or service provider. When that quantity has been met, this embodiment may route calls to vendors who have not yet reached their optimal volume thresholds.

An exemplary embodiment of the present invention determines call allocation thresholds according to contract terms and an analysis of the vendors in the call allocation environment.

An exemplary embodiment of the present invention may be provided as a feature to any existing contact center routing or scheduling tool. The embodiment may assess the current state of the contact handling system for the current billing/measuring period. The parameters for the contact handling system may include, for example, a recent call history, the number and the skills of agents working currently and due to begin shortly, a to-date evaluation of the performance metrics which are included in the contract terms, by agent, and call volume by vendor or other unit included in cost or revenue table. The metrics which may be included in the contract terms may be, for example, Average Handling Time (AHT), First Call Resolution (FCR), Customer Satisfaction (CSAT), and the like.

This embodiment may also forecast call load by type of call for the near-term future (which may be the remainder of the current billing period). Then, based upon this analysis this embodiment may allocate calls to vendors and may also schedule future call allocation and provide a forecast for agents for the near-term future (which may be the remainder of the current billing period).

An exemplary embodiment of the present invention includes a module that determines a desired action on the different metrics of the contract terms and allocates call volumes to each vendor based on current state and forecasts based upon that desired action. This exemplary embodiment may also modify routing and/or scheduling rules to accommodate desired action.

An exemplary embodiment of the present invention provides a system for adding a profit-optimizing component to real-time routing and scheduling for call centers or contact centers, taking into account cost structures, revenue structures, and the way in which performance is rewarded or penalized in the contract terms and conditions, as well as the billing period and the way in which thresholds and values are measured for each billing period.

These and many other advantages may be achieved with the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary contact center management environment 100 in accordance with the present invention;

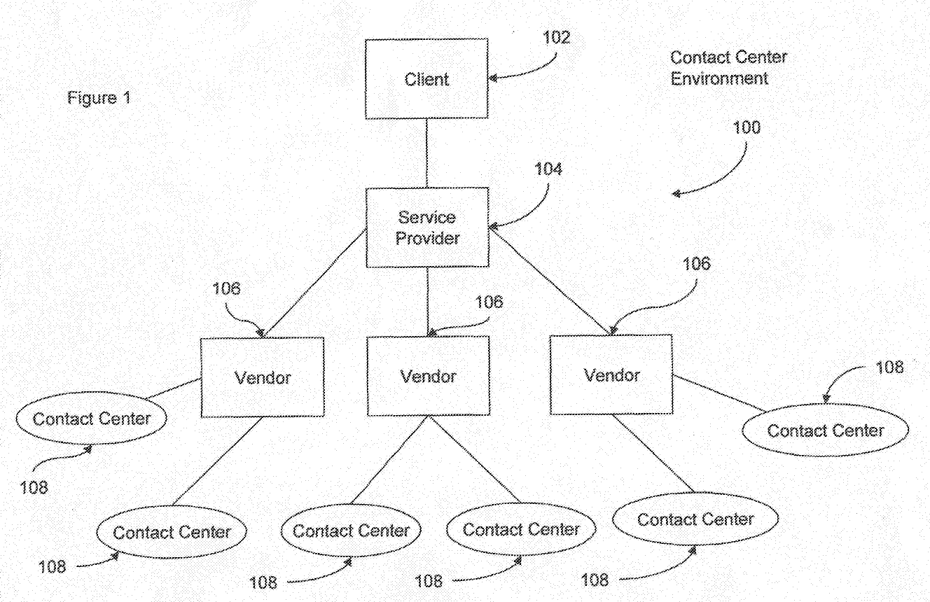

FIG. 2 illustrates an exemplary contact center management system 200 in accordance with the present invention;

FIG. 3 is a flowchart 300 of an exemplary contact management method in accordance with the present invention;

FIG. 4 illustrates a typical hardware configuration 400 which may be used for implementing the inventive system and method for managing contact centers; and

FIG. 5 illustrates exemplary signal bearing media for storing a program embodying an exemplary method for contact center management in accordance with the present invention.

### DETAILED DESCRIPTION OF EXEMPLARY EMBODIMENTS OF THE INVENTION

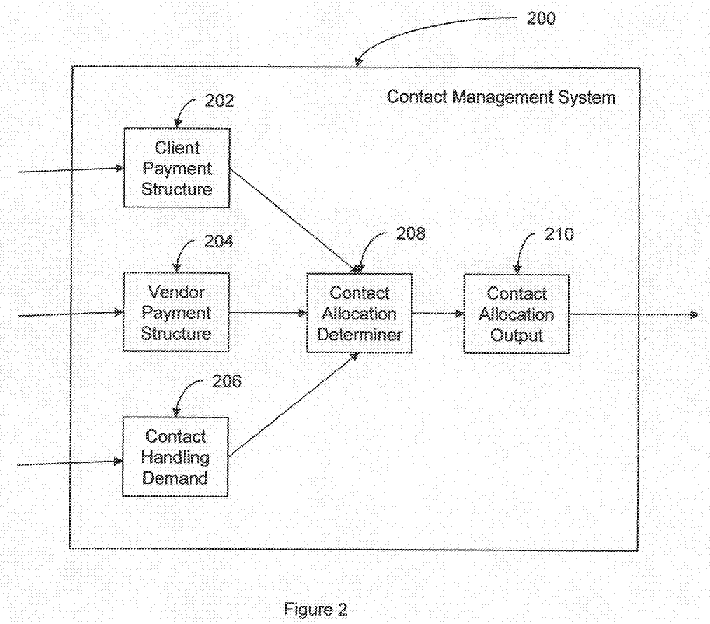

Referring now to the drawings, and more particularly to FIGS. 2-5, there are shown exemplary embodiments of the method and structures of the present invention.

An exemplary embodiment of the present invention takes as input information regarding the contracts in place between the service provider(s) and the client(s), and between the service provider(s) and the third-party vendor(s), who carry out the actual contact center operations.

The information shared between a client and a service provider may include but is not limited to information on billing periods, prices, penalties, bonuses, constraints, and service quality metrics of interest to the client.

The information shared between a service provider and a vendor may include but is not limited to information regarding the price structures (cost per minute, volume discounts, occupancy-rate-dependent prices, etc) they charge, the availability of staff, staff productivity levels, the rates for hiring, firing and overtime, minimum or maximum occupancy (i.e., utilization) levels, maximum variability in occupancy levels from month to month, the skills of the existing staff in terms of the types of calls that they can handle, and the historical quality of service that the staff have provided, on average, for various service quality metrics of interest.

Information on the expected incoming load may also be input into the invention. This expected load may be a forecast of the number of calls or contacts, by type, that is likely to arrive over certain intervals (e.g., the billing period) within the planning horizon.

The following description presents a hypothetical outsourcing situation where there is one client, one service provider and multiple contact center vendors. This formulation is a specific example of how an exemplary method in accordance with the present invention may be implemented.

The client may forecast the volume (for example, in minutes) of calls it expects to receive over a planning horizon (for example the next 12 months). Call volume forecasts may be classified by “line of business” (LOB). In this example, the skills, or training, of a call center staff are done by line of business, which is representative of the content of the call. In general, a line of business may be associated with either a specific skill or a specific collection or combination of skills. The client outsources the management of its calls to the service provider. The service provider does not directly handle the client's calls. Instead, it directs the client's calls to multiple contact center vendors. Each vendor may in turn manage centers located at multiple sites, and each vendor site may only be capable of handling calls belonging to a subset of all lines of business. Vendors also may have a limited capacity to handle calls at each site. Therefore, the service provider decides how to allocate or assign the client's forecasted call volume (on a month-to-month basis) to each vendor, subject to the aforementioned constraints on the vendors.

According to a contract, the client pays the service provider according to the volume of calls that is managed by the service provider. In particular, the client may pay a fixed rate per minute of calls managed. This rate may vary according to the vendor site that ultimately handles the call. Furthermore, this rate may vary according to the line of business of the call. In addition, this rate may vary according to the volume of calls that the vendor is handling. This last variation can be the most complex in that the per minute rate may go up or down as the total number of minutes handled increases, and this usually occurs in between fixed thresholds. There may also be service level agreements that the service provider has with the client. In particular, the client and service provider may agree on targeted performance using, for example, the following measures: Average Handling Time (AHT), First Call Resolution (FCR) and Customer Satisfaction (CSAT). For AHT and FCR, the client might pay a bonus to the service provider when the service provider outperforms the targeted levels. The bonus paid may be proportional to the degree to which the service provider outperforms the targeted levels. For all three metrics, when the targeted performance is not achieved, the service provider may pay a penalty to the client. For AHT and FCR, the penalty paid may be proportional to the degree to which the target is missed. For CSAT, however, the penalty paid may be proportional to the total revenue earned by service provider from the client (excluding bonuses).

The service provider may pay each vendor according to the volume of calls that the vendor handles. The payment to each vendor may depend not only on the total minutes of each LOB handled by the vendor, but also on the utilization, or occupancy level, of the vendor. The occupancy level at a call center (or vendor) may be defined as the ratio of the total volume of calls allocated to the call center (or vendor) and the total call volume capacity of the call center (or vendor).

The payments that the service provider pays to a vendor may possess several different structures, depending on the type of vendor. One type of vendor, referred to as a ‘regular’ vendor, may employ an “all-units” discounting scheme. Under this scheme, the rate that the vendor charges the service provider decreases with increasing call volume and occupancy level. That is, the vendor defines a rate for every combination of call volume and occupancy level. This rate may be constant within a certain range of values of call volume and occupancy level, and may decrease only after the call volume and occupancy levels exceed certain pre-determined threshold levels. There may exist several such threshold levels. The discounted rate may be applied to all calls at a given ‘regular’ vendor site. In general, different vendors may charge the service provider different rates.

A second type of vendor, may be referred to as a ‘through’ vendor. A through vendor may employ an incremental discounting scheme. Under this scheme, the rate that the vendor charges the service provider also decreases with increasing call volume handled and occupancy level at a given vendor site. However, a given discounted rate applies only to the portion of the call volume that lies in the range between the thresholds corresponding to the discounted rate. When determining the payment to a ‘through’ vendor, call volumes may be aggregated across all sites belonging to the vendor.

Depending on who (i.e., the client, the service provider or a vendor) is utilizing the invention, the objective of the underlying optimization method may vary. Assuming that the invention is used by a service provider, then a reasonable objective may be to maximize the service provider's profit.

FIG. 2 illustrates one exemplary contact management system 200 in accordance with the present invention. The contact management system 200 receives a client payment structure 202 based upon a contract between the service provider 104 and the client 102. The contact management system 200 also receives a vendor payment structure 204 based upon a contract between the service provider 104 and the vendor(s) 106. The contact management system 200 also receives a contact handling demand 206 from the client 102. The contact handling demand 206 may include real-time data regarding the type and volume of contacts that require handling. The contact management system 200 may also include a contact allocation determiner 208 that determines the allocation of the contacts among the vendors 106. The contact allocation determiner 208 determines an allocation of contacts based upon real-time profit-maximizing routing and/or scheduling of calls and agents. The contact management system 200 further includes a contact allocation output device 210 that outputs the contact allocation that is received from the contact allocation determiner 208.

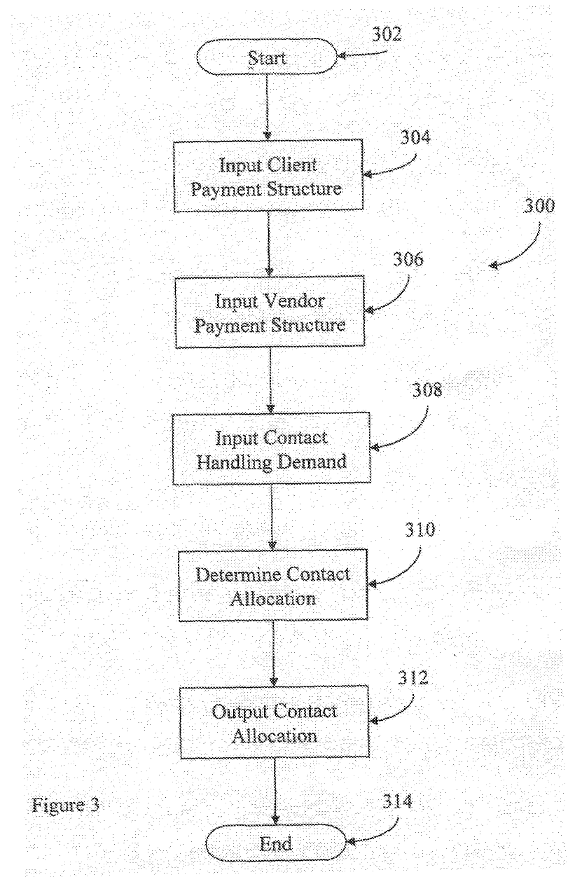

FIG. 3 is a flowchart 300 of one exemplary method in accordance with the present invention. The flowchart starts at step 302 and continues to step 304, where the contact management system 200 inputs the client payment schedule based upon the contract between the client 102 and the service provider 104. Next, the method inputs the vendor(s) payment structure in step 306 based upon the contact(s) between the service provider 104 and the vendor(s) 106. The method continues to step 308 where the method inputs the real-time contact handling demand from the client 102 and continues to step 310.

In step 310, the method determines the contact allocation based upon the input client payment structure, the input vendor payment structure, and the real-time input contact handling demand based upon a real-time analysis of a profit-maximizing routing and/or scheduling of calls and agents, and continues to step 312. In step 312, the method outputs the determined contact allocation to a user and then ends in step 314.

To formulate the hypothetical situation previously described, the following notation is defined. Each of these parameters depends upon the current instant in time. Some parameters, noted below, depend on other instants in time as well.

### Sets and Parameters:

P is the set of all LOBs
V_{R} is the set of regular Vendors
V_{T} is the set of through Vendors
S is the set of all Sites
Sᵥ ⊂ S is the subset of sites that belong to vendor v ε V_{R} ∪ V_{T}
vₛ is the vendor of site s ε S
T=Number of months in planning horizon
Nᵥ=Number of call volume threshold ranges for vendor v ε V_{R} ∪ V_{T}
Oᵥ=Number of occupancy threshold ranges for vendor v ε V_{R} ∪ V_{T}
cₛₚₜ=Capacity (in minutes) at site s for LOB p in month t, where s ε S, p ε P, t=1,2, . . . ,T
dₚₜ=Call Volume Forecast (in minutes) for LOB p in month t, where p ε P, t=1,2, . . . , T.

### Client Service Level Related Contract Parameters:

AHTₛ=Historical average handling time (see, per call) at site s ε S
FCRₛ=Historical average fraction of calls handled within first response at site s ε S
CSATₛ=Historical average customer satisfaction rating site s ε S
AHTₜ=Target AHT in month t=1,2, . . . , T
FCRₜ=Target FCR in month t=1,2, . . . , T
CSATₜ=Target CSAT in month t=1,2, . . . , T

### Objective Function Parameters:

Tₛ=Revenue earned from client per minute allocated to site s ε S
fᵥₙₒ=Payment rate to vendor v ε V_{R} ∪ V_{T} per minute allocated at call volume threshold range n=1, . . . , Nᵥ and occupancy threshold range o=1, . . . , O_{c}
bᵥₙₒ=Cumulative payment to vendor v ε V_{T} up to call volume threshold range n=1, . . . , Nᵥ for occupancy threshold range o=1, . . . , Oᵥ
c₊^{AHT}=Per minute bonus for undershooting AHT target
c₋^{AHT}=Per minute penalty for overshooting AHT target, c₊^{AHT}<c₋^{AHT}
c₊^{FCR}=Per minute bonus for overshooting FCR target
c₋^{FCR}=Per minute penalty for undershooting FCR target, c₊^{FCR}<c₋^{FCR}
c₋^{CSAT}=Per minute penalty for undershooting CSAT target
fᵥₙₒ=Rate (in dollars per minute) charged by vendor v for in call volume threshold range n and occupancy threshold range o, where n=1,2, . . . , Nᵥ and o=1,2, . . . , Oᵥ
bᵥₙₒ=Amount that would be charged by vendor v if the vendor's total call volume exactly fills threshold range n and occupancy threshold range o, where n=1,2, . . . , Nᵥ and o=1,2, . . . , Oᵥ
LBᵥₒ^{vol}=Upper limit on call volume in threshold range n=1,2, . . . , Nᵥ for vendor v ε V_{R} ∪ V_{T}
UBᵥₒ^{vol}=Lower limit on call volume in threshold range n=1,2, . . . , Nᵥ for vendor v ε V_{R} ∪ V_{T}
LBᵥₒ^{occ}=Lower limit on occupancy level in threshold range o=1,2, . . . Oᵥ for vendor v ε V_{R} ∪ V_{T}
UBᵥₒ^{occ}=Lower limit on occupancy level in threshold range o=1,2, . . . Oᵥ for vendor v ε V_{R} ∪ V_{T}

The decisions that will influence the service provider's profit may be captured both directly and indirectly by the following variables. In this notation, there is no distinction between multiple agents trained to answer calls from the same line of business (LOB) at the same site. If there are substantial differences across such agents, then the index for LOB, p, can take on more values such as a separate p for each agent in a LOB. In most cases, however, it would be sufficient to group agents in a single site trained to answer a single LOB in a group, and within that group allocate calls to the longest-available agent.

$$\text{?}$$

$$\text{?} \text{indicates text missing or illegible when filed}$$

The primary decision variables are captured in xₛₙₒₚₜ, the allocation of calls from various LOBs to various vendors in each month. All other decision variables are auxiliary variables which are influenced by the value of xₛₙₒₚₜ.

The optimization model may be a formulation as a mixed-integer program as follows. It can be run periodically with parameters made up-to-date by the most recent state information. The period at which this model is re-solved varies with the computational capacity available. If a billing period is monthly, it may be updated and re-solved once a day, or once every few days.

$$\begin{matrix} Objective Function & \\ \begin{matrix} max Z = \sum \text{?} \\ \text{?} \sum \text{?} f \text{?} \\ \text{?} \sum \text{?} [ \text{?} b \text{?} + λ \text{?} ( UB \text{?} - LB \text{?} ) f \text{?} ] \\ \text{?} {\sum }_{p t} {d}_{p t} ( \text{?} ) \\ \text{?} {\sum }_{p t} {d}_{p t} / A \overline{H} {T}_{t} ( \text{?} ) \\ \text{?} {\sum }_{t} \text{?} {z}_{t}\end{matrix} \\ \text{?} \text{indicates text missing or illegible when filed} & \begin{matrix}( 1 ) \\ ( 2 ) \\ \\ ( 3 ) \\ \\ ( 4 ) \\ \\ ( 5 ) \\ \\ ( 6 )\end{matrix}\end{matrix}$$

The service provider's objective at any point in time may be expressed by the equation comprised of the terms (1)-(6). In the objective function, term (1) captures the revenue earned from the total volume of the client's calls that are managed by the service provider. Term (2) captures the payments that the service provider makes to regular vendors. Term (3) captures the payments that the service provider makes to ‘through’ vendors. Term (4) captures the bonus (or penalty) earned (or paid) by the service provider for its performance with respect to the FCR target. Term (5) captures the bonus (or penalty) earned (or paid) by the service provider for its performance with respect to the AHT target. Term (6) captures the penalty paid by the service provider to the client if it fails to meet the CSAT target.

$$Forecast Satisfaction Constraint \\ {\sum }_{sno} \text{?} = {d}_{p t} ∀ p ∈ P , t = 1 , … , T \\ \text{?} \text{indicates text missing or illegible when filed} \qquad ( 7 )$$

Equation (7) ensures that the forecasted call volume is satisfied by the service provider's allocation. In the case where vendor capacity is insufficient to handle the total forecasted call volume, a ‘dummy’ vendor with sufficiently large capacity and sufficiently high cost can be used to ‘handle’ all overflow calls. Any calls ‘handled’ by the dummy vendor in the solution to the model are unsatisfied in reality.

$$Vendor Capacity Constraint \\ \sum \text{?} \leq {\sum }_{p} c \text{?} ∀ s ∈ S , t = 1 , … , T \\ \text{?} \text{indicates text missing or illegible when filed} \qquad ( 8 )$$

Inequality (8) ensures that the service provider's allocation of calls to the vendors does not exceed the vendors' capacity to handle the allocated line of businesses. When a vendor site does not have any staff that possesses the skills to handle a particular line of business, then the site's capacity for that line of business is considered to be zero.

$$\text{?}$$

$$\text{?} \text{indicates text missing or illegible when filed}$$

Inequalities (9), (10), (13) and (14) jointly determine the qualifying discount rate for the occupancy level and call volume handled at each site belonging to a regular vendor. Inequalities (11), (12), (15) and (16) jointly determine the qualifying discount rate for the occupancy level and call volume handled at each site belonging to a ‘through’ vendor. Equation (17) separates the call volume handled by a ‘through’ vendor in terms of the number of discount ranges that it fully traverses, and the fraction of the discount range that it only partially traverses.

$$\begin{matrix} \text{?} & \\ \text{?} & ( 18 ) \\ \text{?} \text{?} \text{indicates text missing or illegible when filed} & ( 19 )\end{matrix}$$

Inequalities (18) and (19) ensure that, for each vendor, no more than one payment rate is applied in a given month.

$$\begin{matrix} \text{?} & ( 20 ) \\ \text{?} & ( 21 ) \\ \text{?} \\ \text{?} \text{indicates text missing or illegible when filed} & ( 22 )\end{matrix}$$

Equations (20), (21) and (22) determine the extent to which the AHT, FCR and CSAT performance, respectively, outperforms or misses its target. These are critical parameters to update at least prior to each time that the model is re-solved.

$$\text{?}$$

$$\text{?} \text{indicates text missing or illegible when filed}$$

Inequalities (23), (24) and (25) are used to determine the penalty to be paid with respect to the CSAT service level metric. The penalty is greater than zero only if the CSAT target is missed. These linear inequalities are used to avoid expressions in the objective function which involve the multiplication of two or more decision variables with each other.

The solution to the optimization model will produce the values of xₛₙₒₚₜ that will result in the maximum profit for the service provider. If an alternative objective function is used (e.g., minimize client payments to service provider), then the values of xₛₙₒₚₜ produced by solving the modified optimization model will be the values that will optimize the new objective function.

For example, one vendor may have a contract that requires a minimum number of calls per month or a penalty will be paid to that vendor. An exemplary embodiment of the present invention accounts for this contract term and recommends an allocation of calls to that vendor to ensure that the minimum number of calls is received by that vendor, to thereby maximize profitability of the service provider.

Further, in this example, during the contract period, the exemplary embodiment may shift calls away from a different vendor which may have a lower cost per call, to the vendor with the minimum call contract term to ensure that the term is satisfied despite the fact that the vendor with the minimum call contract term may have a higher per call cost. This embodiment allocates calls to maximize profitability and/or minimize cost.

An exemplary embodiment of the present invention receives parameters regarding the real-time current state of the system and the terms of the contract between the service provider and all vendors to determine how to allocate calls across the vendors to maximize profitability.

While the above described a specific engine, the engine that is used to allocate the calls among the clients may be any type of engine as long as the calls are allocated in a manner which is based upon the terms of the contract. While the above described engine may be complicated, another engine may be used which is more simple. However, the structure is the same in that the invention receives terms from the contract, and receives real-time demand, projected future demand for the remainder of the billing cycle, actual performance levels and projected future levels for the remainder of the billing cycle, as well as the current allocation from the start of the billing cycle to the present time.

Certain policies, such as for example, a requirement not to exceed a maximum wait time, a requirement for minimum quality level, and the like may create a conflict. Conflicts between these policies are resolved using the profitability function.

An exemplary embodiment of the invention evaluates the current state of the profitability with reference to the contract terms upon receiving a call and allocates that call to maximize profitability.

An exemplary embodiment of the present invention may evaluate the trends in the types of calls that are being received and may establish a forecast for calls that may be received for the remainder of a time period and allocate calls based upon that forecast and the terms of the contract to maximize profitability. For example, a vendor may require a minimum number of calls be received within a particular period of time and the system may determine that if the current ratio of calls being allocated to that vendor is maintained and given the forecast for the amount of calls that are expected to be received, the minimum number might not be achieved and a penalty payment may become due to that vendor. This exemplary embodiment of the invention may recognize this situation, and may shift more (or less) calls to that vendor to avoid the penalty and to thereby maximize profitability.

Such forecasting can take into account seasonality and/or any historical anticipated trends. The current rate of calls may indicate a trend that may adjust the forecast for the calls. No particular mechanism for providing this forecast is required.

An exemplary embodiment of the present invention may provide alerts and/or notifications of pending call allocation changes. For example, the embodiment may alert a vendor that the system will be allocating more calls to a particular vendor so that the vendor may be prepared for the increase volume when the calls arrive. This can be especially valuable if a plan for allocation was previously published and being followed and the plan may be changed in a manner which may significantly affect any particular vendor. It may be helpful to alert that vendor of the unanticipated allocation plan change.

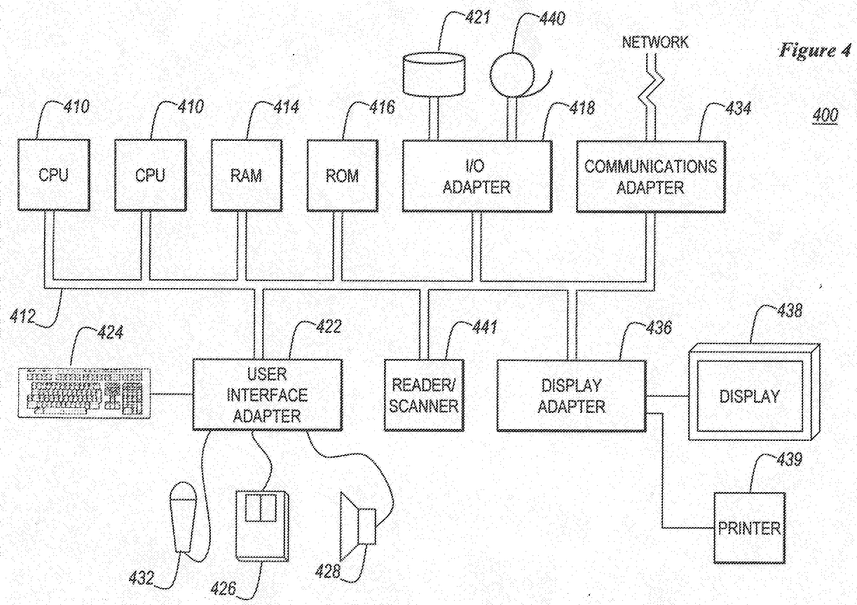

Referring now to FIG. 4, system 400 illustrates a typical hardware configuration which may be used for implementing the inventive system and method for managing contact centers. The configuration has preferably at least one processor or central processing unit (CPU) 410. The CPUs 402 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting an information handling system to a data processing network, the Internet, and Intranet, a personal area network (PAN), etc., and a display adapter 436 for connecting the bus 412 to a display device 438 and/or printer 439. Further, an automated reader/scanner 441 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a computer programmed product, including signal-bearing media tangibly embodying a program of machine-readable instructions executable by a digital data processor to perform the above method.

Such a method may be implemented, for example, by operating the CPU 410 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 410 and hardware above, to perform the method of the invention.

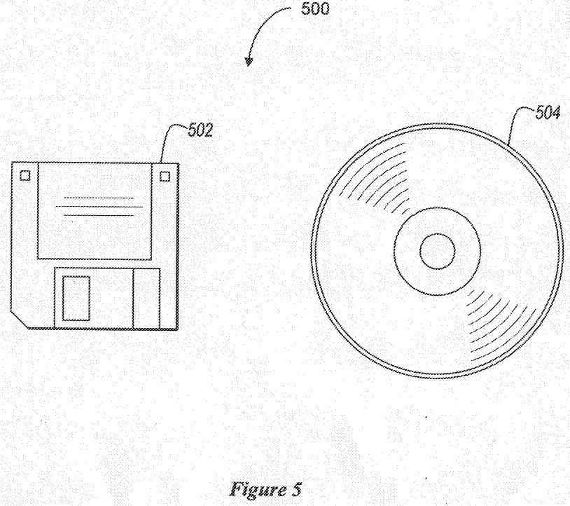

This signal-bearing media may include, for example, a RAM contained within the CPU 410, as represented by the fast-access storage for example. Alternatively, the instructions may be contained in another signal-bearing media, such as a magnetic data storage diskette 500 or CD-ROM 502, (FIG. 5), directly or indirectly accessible by the CPU 410.

Whether contained in the computer server/CPU 410, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media. In an illustrative embodiment of the invention, the machine-readable instructions may comprise software object code, complied from a language such as “C,” etc.

While the invention has been described in terms of several exemplary embodiments, those skilled in the art will recognize that the invention can be practiced with modification.

Further, it is noted that, Applicant's intent is to encompass equivalents of all claim elements, even if amended later during prosecution.

What is claimed is:

1. A method of allocating contacts to a vendor, comprising:
determining a real-time allocation of a contact based upon any of a client-to-service provider payment structure, a service provider-to-vendor payment structure, and a real-time client contact handling demand.

2. The method of claim 1, further comprising:
receiving the client-to-service provider payment structure;
receiving the service provider-to-vendor payment structure; and
receiving the real-time client contact handling demand.

3. The method of claim 1, wherein the determining of a real time allocation of a contact to a vendor comprises determining a real-time allocation of a contact from a client among a plurality of vendors.

4. The method of claim 1, wherein the service provider-to-vendor payment structure comprises a plurality of payment structures to a plurality of vendors, and wherein the client-to-service provider payment structure comprises a plurality of payment structures from a plurality of clients to said service provider.

5. The method of claim 1, wherein one of the client-to-service provider payment structure and the service provider-to-vendor payment structure comprises a non-linear structure.

6. The method of claim 1, wherein said determining a real-time allocation of a contact optimizes an objective function provided by a user.

7. The method of claim 6, wherein optimizing said objective function comprises one of minimizing a cost to said client, maximizing a profit to said service provider, maximizing revenue to said service provider, minimizing cost to said service provider, maximizing revenue to said vendor, and minimizing variability in staff utilization levels at said vendor.

8. The method of claim 1, further comprising determining a forecasted allocation of resources by said vendor based upon said determined allocation of a contact, wherein said allocation of resources comprises one of a staffing level adjustment, a hiring, a firing, and a training action.

9. The method of claim 1, further comprising receiving a description of the resources available at said vendor for handling contacts, wherein said determining of the allocation of contacts is based upon said description of the resources available at said vendor for handling contacts.

10. A system for allocating contacts to a vendor, comprising:
a contact allocation determiner that determines a real-time allocation of a contacts to said vendor based upon one of a client-to-service provider payment structure, a service provider to vendor payment structure, and a current client contact handling demand.

11. The system of claim 10, further comprising:
a client payment structure storage in communication with said contact allocation determiner;
a vendor payment structure storage in communication with said contact allocation determiner; and
a real-time contact handling demand storage in communication with said contact allocation determiner.

12. The system of claim 10, wherein said contact allocation determiner determines an allocation of a contact among a plurality of vendors.

13. The system of claim 10, wherein one of the client-to-service provider payment structure and the service provider-to-vendor payment structure comprises a non-linear structure.

14. The system of claim 10, wherein said contact allocation determiner optimizes in real-time an objective function provided by a user.

15. The system of claim 14, wherein said real-time optimizing of said objective function comprises one of minimizing a cost to said client, maximizing a profit to said service provider, maximizing revenue to said service provider, minimizing cost to said service provider, maximizing revenue to said vendor, and minimizing variability in staff utilization levels at said vendor.

16. The system of claim 10, wherein said contact allocation determiner further determines in real-time the allocation of resources by said vendor based upon said determined allocation of contacts.

17. The system of claim 10, wherein said contact allocation determiner further determines the allocation of a contact in real-time based upon a description of the resources available at said vendor for handling contacts.

18. The system of claim 10, wherein said real-time client contact handling demand comprises one of a real-time volume of contacts, a required level of skill, a line of business, a required level of quality, a current average handling time, a current first call resolution, and a current customer satisfaction level.

19. A program embodied in a computer readable medium executable by a digital processing system for allocating a contact to a vendor, said program comprising instructions for executing the method of claim 1.

20. A system for allocating contacts to a vendor comprising:
means for determining a real-time allocation of a contact to said vendor based upon one of a client-to-service provider payment structure, a service provider-to-vendor payment structure, and a real-time client contact handling demand; and
means for determining a forecasted allocation of resources by said vendor based upon said determined allocation of a contact.
